(19) United States
(12) Patent Application Publication
(10) Pub. No.: US 2022/0220319 A1
(43) Pub. Date: Jul. 14, 2022

(54) THERMALLY EXPANDABLE PREPARATION

(71) Applicant: Henkel AG & Co. KGaA, Duesseldorf (DE)

(72) Inventors: Ralf Sauer, St. Leon-Rot (DE); Michael Klotz, Edingen-Neckarhausen (DE); Fiona Cappel, Sandhausen (DE)

(21) Appl. No.: 17/590,262

(22) Filed: Feb. 1, 2022

Related U.S. Application Data
(63) Continuation of application No. PCT/EP2020/074417, filed on Sep. 2, 2020.

(30) Foreign Application Priority Data
Sep. 6, 2019 (EP) 19195801.6

(51) Int. Cl. C09D 5/02; C09D 7/65; C09D 7/40; C09D 7/61; C09D 133/10; B60R 13/08

(52) U.S. Cl. CPC C09D 5/024; C09D 7/65; C09D 7/70; B60R 13/08; C09D 7/69; C09D 133/10; C09D 7/61

(57) ABSTRACT

The present application relates to a thermally expandable preparation containing at least one binder, at least one physical blowing agent, at least two polysaccharides and water, to a method for soundproofing using such preparations, and to the corresponding use of these preparations.

The present application relates to a thermally expandable preparation which contains the constituents disclosed herein, to a method for soundproofing structural components having in particular thin-walled structures using such preparations, and to the use of these preparations for soundproofing such structures.

In modern vehicle construction (car/truck/bus/train), add-on parts, paneling, but also, for example, the roof area and the vehicle floor are equipped with acoustically damping masses in order to reduce or prevent the various vibrations of the structure and thus the noise transmission in the application range from −40 to +90° C. These damping masses are often based on bitumen in the form of mats on the market, which have to be specially tailored to each vehicle geometry. Injectable and extrudable damping compounds based on rubber, epoxy and aqueous (acrylate) dispersions are also known. All of these damping masses are applied to the vehicle over a large surface area, mainly in the body structure or in the paint area.

In particular, water-based systems are used for soundproofing or sound damping. However, these systems contain water, which escapes after application and when heated. In the automotive industry in particular, the preparations are put into the furnace after application, for example together with the automobile body. During heating, typically with a temperature increase of 10° C./min, and baking, typically at temperatures between 100 and 200° C. for 30 minutes, the water escapes in an uncontrolled manner, which leads to the formation of bubbles, which creates an uneven surface. In order to suppress the formation of bubbles, corresponding water-based systems often contain a very small proportion of blowing agent, as a result of which low expansion rates of up to 40 vol. % can be achieved. Alternatively, the preparations contain a large amount of additional stabilizers, which often lead to greater water absorption by the resulting foams.

Accordingly, it was the object of the present invention to provide preparations for the production of foams, in particular for soundproofing, which overcome the disadvantages mentioned above. In particular, there should be a reduced formation of bubbles during production.

In addition, in the current age of automating production processes using robots, it is desirable if the components for soundproofing can be applied directly by means of a robot. This saves time and money, and the production process can also be quickly adapted to other structural components and geometries by reprogramming the robot. For this purpose, it is, however, particularly desirable if the substance suitable for soundproofing can be applied directly by the robot.

Surprisingly, it has now been found that thermally expandable preparations which contain the combination of components described herein demonstrate such behavior. In particular, the combination of two starches and a physical blowing agent in the aqueous preparations ensures that the formation of bubbles can be almost completely suppressed. The resulting products also have a very smooth and even surface, and good soundproofing can also be achieved. In addition, corresponding preparations can be designed to be pumpable, which is why they can be applied using robots.

The present invention therefore relates to thermally expandable preparations containing

(a) at least one binder;
(b) at least one physical blowing agent;
(c) at least two polysaccharides and
(d) water.

“At least one,” as used herein, means one or more, i.e., 1, 2, 3, 4, 5, 6, 7, 8, 9 or more. In relation to an ingredient, the expression refers to the type of ingredient and not to the absolute number of molecules. “At least one polymer” thus means, for example, at least one type of polymer, i.e., one type of polymer or a mixture of a plurality of different polymers may be meant. Together with weight specifications, the expression relates to all compounds of the type indicated that are contained in the composition/mixture, i.e., that the composition does not contain any other compounds of this type beyond the indicated amount of the corresponding compounds.

Where reference is made in this document to molecular weights of polymer compounds, the figures refer to the number-average molecular weight Mn, unless specified otherwise. The molecular weight, whether a number-average or weight-average molecular weight, can be determined by means of GPC against a polystyrene standard.

Unless explicitly indicated otherwise, all percentages that are cited in connection with the preparations described herein relate to wt. %, in each case based on the relevant preparation or composition.

The terms “about” or “approximately” in connection with a numerical value refer to a variance of ±10% in relation to the specified numerical value.

Unless stated otherwise, the molecular weights indicated in the present text relate to the weight-average molecular weight (Mw). The molecular weight Mw can be determined by gel permeation chromatography (GPC) with polystyrene as the standard and THF as the eluent. Except where indicated otherwise, the listed molecular weights are those which are determined by means of GPC. The number-average molecular weight Mn can also be determined by means of GPC, as indicated previously.

A substance is “solid” if it is in the solid state of aggregation at 20° C. and 1013 mbar. The substance is in a solid state of aggregation if the geometry of the substance does not deform under the influence of gravity within 1 hour, in particular within 24 hours, under the specified conditions. In the context of the invention, “liquid” means that the corresponding compound/component is not in solid form under standard conditions, i.e., 20° C. and 1013 mbar. Therefore, pasty substances are also liquid in the context of this invention. Under standard conditions, a liquid substance is preferably flowable and thus, for example, can be poured out of a container. A liquid substance preferably has a viscosity of up to 250 Pa*s at 20° C. Unless stated otherwise, the viscosities are determined in the context of the present application under the following measurement conditions: rotation rheometer having a plate-plate geometry (PP20); measured in oscillation at 10% deformation and a frequency of 100 rad/s; layer thickness of the material=0.2 mm.

The thermally expandable preparations contain at least one binder. In another embodiment, the thermally expandable preparation can also contain a binder system as a binder. In the case of a binder system, the preparations preferably contain at least one binder and at least one curing agent and/or accelerator, in particular a thermally activatable curing agent.

Preferably, the curing agent and/or accelerator is generally present in a total amount of at least 0.25 wt. %, and in particular at least 1.5 wt. %, based on the total composition. However, a total of more than 15 wt. %, based on the total weight of the composition, is generally not required. However, the proportion of the curing agent and/or accelerator can vary widely, depending on the system used.

Preferably, the curing agent is selected such that the curing agent is a thermally activatable curing agent, and therefore the crosslinking temperature T90 of the system is preferably above 70° C., in particular above 100° C. The crosslinking temperature T90 is defined as the temperature at which 90% of the crosslinking of the material is achieved within 12 minutes. The crosslinking temperature T90 and the degree of crosslinking can be determined by means of a rheometer measurement, as with a Monsanto Rheometer 100 S (principle: oscillating disc at a deflection angle of 3°, approx. 15 cm3 chamber volume) according to DIN 53529.

The proportion of the binder in the total composition can generally be within the range of from 2 to 65 wt. %. However, the proportion of the binder can vary widely, depending on the binder used. Preferred binders of the compositions are selected from the group of epoxides, thermoplastic elastomers, peroxidically crosslinkable polymers or (meth)acrylate-based polymers.

A preferred subject therefore contains epoxides as the binder. A plurality of polyepoxides having at least two 1,2-epoxy groups per molecule are suitable as epoxy resins. The epoxide equivalent of these polyepoxides can vary between 150 and 50,000, preferably between 170 and 5,000. In principle, the polyepoxides may be saturated, unsaturated, cyclic or acyclic, aliphatic, alicyclic, aromatic or heterocyclic polyepoxide compounds. Examples of suitable polyepoxides include polyglycidyl ethers prepared by reacting epichlorohydrin or epibromohydrin with a polyphenol in the presence of an alkali. Polyphenols suitable for this are, for example, resorcinol, pyrocatechol, hydroquinone, bisphenol A (bis-(4-hydroxy-phenyl)-2,2-propane)), bisphenol F (bis(4-hydroxyphenyl)methane), bis(4-hydroxyphenyl)-1,1-isobutane, 4,4′-dihydroxybenzophenone, bis(4-hydroxyphenyl)-1,1-ethane and 1,5-hydroxynaphthaline. Other polyphenols that are suitable as the basis for polyglycidyl ethers are the known condensation products of phenol and formaldehyde or acetaldehyde of the novolac resin type.

Other polyepoxides that are in principle suitable are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other polyepoxides are polyglycidyl esters of polycarboxylic acids, for example reaction products of glycidol or epichlorohydrin with aliphatic or aromatic polycarboxylic acids such as oxalic acid, succinic acid, glutaric acid, terephthalic acid or dimer fatty acid.

Other epoxides are derived from the epoxidation products of olefinically unsaturated cycloaliphatic compounds or from native oils and fats.

Guanidines, substituted guanidines, substituted ureas, melamine resins, guanamine derivatives, cyclic tertiary amines, aromatic amines and/or mixtures thereof can be used as thermally activatable or latent curing agents for the epoxy resin binder system consisting of the aforementioned components. In this case, the curing agents can be stoichiometrically involved in the curing reaction. However, they may also have a catalytic effect. Examples of substituted guanidines are methylguanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine, and very particularly cyanoguanidine (dicyandiamide). Representatives of suitable guanamine derivatives include alkylated benzoguanamine resins, benzoguanamine resins or methoxymethyl-ethoxymethylbenzoguanamine. For monocomponent, heat-curing shaped bodies, the selection criterion is the low solubility of these substances at room temperature in the resin system, and therefore solid, finely ground curing agents are preferred in this case. Dicyandiamide is particularly suitable. Good storage stability of the heat-curing shaped bodies is thereby ensured.

In addition to or instead of the aforementioned curing agents, substituted ureas that have a catalytic effect can be used. These are in particular p-chlorophenyl-N,N-dimethylurea (Monuron), 3-phenyl-1,1-dimethylurea (Fenuron) or 3,4-dichlorophenyl-N,N-dimethylurea (Diuron). In principle, it is also possible to use tertiary acrylic or alkyl amines that have a catalytic effect, for example benzyldimethylamine, tris(dimethylamino)phenol, piperidine or piperidine derivatives. However, these are often too soluble in the adhesive system, such that the monocomponent system is not suitably storage stable. Furthermore, various, preferably solid imidazole derivatives can be used as accelerators that have a catalytic effect. Representative examples include 2-ethyl-2-methylimidazole, N-butylimidazole, benzimidazole and N-C1-12-alkylimidazoles or N-arylimidazoles. Particularly preferred is the use of a combination of a curing agent and an accelerator in the form of “accelerated” dicyandiamides in a finely ground form. This means that it is superfluous to separately add accelerators that have a catalytic effect to the epoxide curing system.

In a further preferred embodiment, the at least one thermoplastic elastomer preferably contains a styrene/butadiene or styrene/isoprene block copolymer as a binder. A thermoplastic elastomer is preferably used of which the softening point is no higher than the temperature at which the blowing agent begins to be activated; the softening point is preferably at least approximately 30° C. lower than the activation temperature of the blowing agent. The softening point is determined by means of DSC.

The thermoplastic elastomer is preferably selected from the group consisting of thermoplastic polyurethanes (TPU) and block copolymers (including both linear and radial block copolymers) of the A-B, A-B-A, A-(B-A)n-B and (A-B)n-Y types, where A is an aromatic polyvinyl (“hard”) block and the B block is a rubber-like (“soft”) block of polybutadiene, polyisoprene or the like, which may be partially hydrogenated or is completely hydrogenated, Y is a polyfunctional compound, and n is an integer of at least 3. The hydrogenation of the B block removes the double bonds originally present and increases the thermal stability of the block copolymer. However, there is preferably no hydrogenation.

Suitable block copolymers include, but are not limited to, SBS (styrene-butadiene-styrene) copolymers, SIS (styrene-isoprene-styrene) copolymers, SEPS (styrene-ethylene-propylene-styrene) copolymers, SEEPS (styrene-ethylene-ethylene-propylene-styrene) or SEBS (styrene-ethylene-butadiene-styrene) copolymers. Particularly suitable block copolymers are styrene-isoprene-styrene triblock polymers, and completely or partially hydrogenated derivatives thereof, the polyisoprene block preferably containing a relatively high number of monomer units, derived from isoprene, in a 1,2 and/or 3,4 configuration.

Preferably, at least approximately 50% of the polymerized isoprene monomer units are contained in the polymer in a 1,2 and/or 3,4 configuration, the rest of the isoprene units having a 1,4 configuration. Block copolymers of this kind are available, for example, from Kuraray Co., Ltd. under the trade name HYBRAR.

In certain preferred embodiments of the invention, the “hard” blocks have a proportion by weight of approximately 15 to approximately 30 wt. % of the block copolymer, and the “soft” blocks have a proportion by weight of approximately 70 to approximately 85 wt. % of the block copolymer.

The glass transition temperature of the “soft” blocks is preferably approximately −80° C. to approximately 10° C., whereas the glass transition temperature of the “hard” blocks is preferably approximately 90° C. to approximately 110° C. The melt flow index of the block copolymer is preferably approximately 0.5 to approximately 6 g/10 min (measured in accordance with ASTM D1238, 190° C., 2.16 kg). The block copolymer preferably has a number-average molecular weight of approximately 30,000 to approximately 300,000, measured by means of GPC against a polystyrene standard.

Thermoplastic polyurethanes (TPU) can also be used as thermoplastic elastomers, and so too can other block copolymers containing hard and soft segments, such as polystyrene-polydimethylsiloxane block copolymers, polysulfone-polydimethylsiloxane block copolymers, polyester-polyether block copolymers (e.g. copolyesters such as those consisting of dimethyl terephthalate, poly(tetramethylene oxide)glycol and tetramethylene glycol), polycarbonate-polydimethylsiloxane block copolymers and polycarbonate-polyether block copolymers.

Thermoplastic elastomers that are not block copolymers are generally finely interdispersed multiphase systems or alloys and can also be used, including mixtures of polypropylene with ethylene propylene rubber (EPR) or ethylene propylene diene monomer rubber (EPDM).

In this embodiment involving one or more thermoplastic elastomers, the expandable material preferably contains one or more non-elastomeric thermoplastic polymers. In this case, the non-elastomeric thermoplastic polymer is selected, inter alia, in order to improve the adhesion properties and workability of the expandable composition.

Generally, it is desirable for a non-elastomeric thermoplastic polymer to be used of which the softening point is no higher than the temperature at which the blowing agent begins to be activated, which softening point is preferably at least approximately 30° C. lower than said activation temperature.

The particularly preferred non-elastomeric thermoplastic polymers include olefin polymers, in particular copolymers of olefins (e.g. ethylene) having non-olefinic monomers (e.g. vinyl esters, such as vinyl acetate and vinyl propionate, (meth)acrylate esters, such as C1 to C6 alkyl esters of acrylic acid and methacrylic acid). Ethylene-vinyl acetate copolymers (specifically copolymers having a proportion of approximately 16 to 35 wt. % of vinyl acetate) and ethylene-methyl acrylate copolymers (in particular copolymers having a proportion of approximately 15 to approximately 35 wt. % of methyl acrylate).

In certain configurations of this embodiment, the weight ratio of the thermoplastic elastomer to the non-elastomeric thermoplastic polymer is at least 0.5:1 or at least 1:1 and/or no more than 5:1 or 2.5:1.

A further preferred subject of the invention contains at least one peroxidically crosslinkable polymer, preferably in conjunction with one least one peroxide as a curing agent.

In principle, all thermoplastic polymers and thermoplastic elastomers that can be peroxidically crosslinked can be used as peroxidically crosslinkable polymers. A person skilled in the art uses the expression “peroxidically crosslinkable” to refer to polymers in which a hydrogen atom can be abstracted from the main chain or a side chain by the action of a radical initiator, such that a radical is left behind that acts on other polymer chains in a second reaction step.

In a preferred embodiment, the at least one peroxidically crosslinkable polymer is selected from styrene-butadiene block copolymers, styrene-isoprene block copolymers, ethylene-vinyl acetate copolymers, functionalized ethylene-vinyl acetate copolymers, functionalized ethylene-butyl acrylate copolymers, ethylene-methyl acrylate copolymers, ethylene-ethyl acrylate copolymers, ethylene-butyl acrylate copolymers, ethylene-(meth)acrylic acid copolymers, ethylene-2-ethylhexyl acrylate copolymers, ethylene-acryl ester copolymers and polyolefins, such as polyethylene or polypropylene.

According to the invention, a “functionalized copolymer” is understood to mean a copolymer which is provided with additional hydroxide groups, carboxyl groups, anhydride groups, acrylate groups and/or glycidyl methacrylate groups.

Within the meaning of the present invention, ethylene-vinyl acetate copolymers, functionalized ethylene-vinyl acetate copolymers, functionalized ethylene-butyl acrylate copolymers, ethylene-propylene-diene copolymers, styrene-butadiene block copolymers, styrene-isoprene block copolymers, ethylene-methyl acrylate copolymers, ethylene-ethyl acrylate copolymers, ethylene-butyl acrylate copolymers and ethylene-(meth)acrylic acid copolymers are particularly advantageous.

Particularly good adhesion properties can be achieved, in particular on an oiled plate, if thermally curable preparations according to the invention are used which contain one or more ethylene-vinyl acetate copolymers as solely peroxidically curable polymers, i.e. excluding the ethylene-vinyl acetate copolymers, the thermally curable preparations are substantially free of further peroxidically curable polymers.

According to the invention, thermally expandable preparations are “substantially free of further peroxidically curable polymers” when they contain less than 3 wt. %, preferably less than 1.5 wt. %, more particularly preferably less than 0.5 wt. %, of a peroxidically crosslinkable polymer which is not an ethylene-vinyl acetate copolymer.

Thermally expandable preparations which contain at least one ethylene-vinyl acetate copolymer having a vinyl acetate proportion of from 9 to 30 wt. %, in particular from 15 to 20 wt. %, more particularly from 17.5 to 19 wt. %, based on the total weight of the copolymer, are particularly preferred according to the invention.

The thermally expandable preparations preferably contain at least 30 wt. % of at least one peroxidically crosslinkable polymer. Particularly preferred are thermally expandable preparations that contain from 40 to 90 wt. %, in particular from 50 to 80 wt. %, of at least one peroxidically crosslinkable polymer, based in each case on the total weight of the composition.

In addition to the peroxidically crosslinkable polymers, the thermally expandable preparations may also preferably contain, as a further constituent, at least one low-molecular multifunctional acrylate.

A “low-molecular multifunctional acrylate” is understood to be a compound which has at least two acrylate groups and a molar weight of below 2,400 g/mol, preferably below 800 g/mol. In particular, compounds that have two, three or more acrylate groups per molecule have been found to be advantageous.

Preferred difunctional acrylates are ethylene glycol dimethacrylate, diethylene glycol dimethacrylate, triethylene glycol dimethacrylate, triethylene glycol diacrylate, tripropylene glycol dimethacrylate, 1,4-butanediol-dimethacrylate, 1,3 butylene glycol dimethacrylate, 1,3-butanediol dimethacrylate, tricyclodecane dimethanol dimethacrylate, 1,10-dodecanediol dimethacrylate, 1,6-hexanediol dimethacrylate, 2-methyl-1,8-octanediol dimethacrylate, 1,9-nonanediol dimethacrylate, neopentyl glycol dimethacrylate and polybutylene glycol dimethacrylate.

Preferred low-molecular-weight acrylates having three or more acrylate groups are glycerol triacrylate, dipentaerythritol hexaacrylate, pentaerythritol triacrylate (TMM), tetramethylolmethane tetraacrylate (TMMT), trimethylolpropane triacrylate (TMPTA), pentaerythritol trimethacrylate, di(trimethylolpropane) tetraacrylate (TMPA), pentaerythritol tetraacrylate, trimethylolpropane trimethacrylate (TMPTMA), tri(2-acryloxyethyl)isocyanurate and tri(2-methacryloxyethyl)trimellitate and the ethoxylated and propoxylated derivatives thereof having a content of a maximum of 35 EO units and/or a maximum of 20 PO units.

According to the invention, thermally expandable preparations that contain a low-molecular-weight multifunctional acrylate selected from triethylene glycol diacrylate, triethylene glycol dimethacrylate, trimethylolpropane triacrylate (TMPTA) and trimethylolpropane trimethacrylate (TMPTMA), pentaerythritol triacrylate (TMM), tetramethylolmethane tetraacrylate (TMMT), pentaerythritol trimethacrylate, di(trimethylolpropane)tetraacrylate (TMPA) and pentaerythritol tetraacrylate are very particularly preferred.

In addition to the low-molecular acrylates, the thermally expandable preparations may contain further co-crosslinking agents, such as allyl compounds, for example triallyl cyanurate, triallyl isocyanurate, triallyl trimesate, triallyl trimellitate (TATM), tetraallyl pyromellitate, the diallyl esters of 1,1,3-trimethyl-5-carboxy-3-(4-carboxyphenyl)indene, trimethylolpropane trimellitate (TMPTM) or phenylene dimaleimide.

It has been found to be particularly advantageous for the thermally expandable preparations to contain at least one low-molecular-weight multifunctional acrylate selected from triethylene glycol diacrylate, trimethylolpropane triacrylate (TMPTA) and trimethylolpropane trimethacrylate (TMPTMA).

The low-molecular multifunctional acrylates are contained in the thermally expandable preparations preferably in an amount of from 0.2 to 2.5 wt. %, in particular from 0.4 to 1.4 wt. %, based in each case on the total weight of the thermally expandable preparation.

As a curing agent system for the peroxidically crosslinkable polymers, the thermally expandable preparations preferably contain at least one peroxide. In particular, organic peroxides are suitable, for example ketone peroxides, diacyl peroxides, peresters, perketals and hydrogen peroxides. Particularly preferred are, for example, cumene hydroperoxide, t-butyl peroxide, bis(tert-butylperoxy)-diisopropylbenzene, di(tert-butylperoxyisopropyl)benzene, dicumyl peroxide, t-butyl peroxybenzoate, dialkyl peroxydicarbonate, diperoxy ketals (e.g. 1,1-di-tert-butylperoxy-3,3,5-trimethylcyclohexane), ketone peroxides (e.g. methyl ethyl ketone peroxides) and 4,4-di-tert-butylperoxy-n-butyl-valerates.

Peroxides, commercially marketed for example by Akzo Nobel, such as 3,3,5,7,7-pentamethyl-1,2,4-trioxepane, 2,5-dimethyl-2,5-di(tert-butylperoxy)hex-3-yne, di-tert-butyl peroxide, 2,5-dimethyl-2,5-di(tert-butylperoxy)hexane, tert-butyl cumyl peroxide, di-(tert-butylperoxyisopropyl)benzene, dicumyl peroxide, butyl-4,4-di(tert-butylperoxi)valerate, tert-butylperoxy-2-ethylhexyl carbonate, 1,1-di-(tert-butylperoxy)-3,3,5-trimethylcyclohexane, tert-butyl peroxybenzoate, di-(4-methylbenzoyl)peroxide and dibenzoyl peroxide, are particularly preferred.

It has also been found to be advantageous for the peroxides used to be substantially inert at room temperature and to be activated only when heated to relatively high temperatures (for example when heated to temperatures of between 130° C. and 240° C.). It is particularly advantageous for the peroxide used to have a half-life of more than 60 minutes at 65° C., i.e. after the thermally expandable preparation containing the peroxide has been heated to 65° C. for 60 minutes, less than half of the peroxide used has decomposed. According to the invention, peroxides that have a half-life of 60 minutes at 115° C. may be particularly preferred.

At least one peroxide selected from the group of di(tert-butylperoxyisopropyl)benzene, dicumyl peroxide, 1,1-di-(tert-butylperoxy)-3,3,5-trimethylcyclohexane, dibenzoyl peroxide and di-tert-butyl-1,1,4,4-tetramethylbut-2-in-1,4-ylendiperoxide is particularly preferably contained.

According to the invention, it is also advantageous for at least one peroxide or the peroxides to be used in a form in which they are applied to a solid inert carrier, such as calcium carbonate and/or silica and/or kaolin.

Preferably, the peroxide is selected such that the crosslinking temperature T90 is below, preferably 15-35° C. below, the decomposition temperature of the endothermic blowing agent. This ensures a high gas yield and thus a high degree of expansion of the material. Examples would be a peroxide (T90=105° C.) with sodium bicarbonate start decomposition temperature 130° C. or a peroxide (T90=170° C.) with citric acid start decomposition temperature 195° C. The crosslinking temperature T90 is defined as the temperature at which 90% crosslinking of the material is achieved within 12 minutes.

The at least one peroxide or the peroxides is/are contained in the thermally expandable preparations according to the invention preferably in an amount of from 0.2 to 2 wt. %, in particular in an amount of from 0.5 to 1.3 wt. %, the active substance content of peroxide being based in each case on the total weight of the thermally expandable preparation.

Furthermore, it is advantageous for the weight ratio of the at least one peroxide to the at least one low-molecular multifunctional acrylate to be at least 1:3. A weight ratio of at least 1:3 is always achieved according to the invention if the formulation contains at most 3 g of the low-molecular multifunctional acrylate, based on 1 g of peroxide. A weight ratio of at least 1:2.5, in particular at least 1:1.6, is particularly preferred.

By selecting this weight ratio, it is possible according to the invention for the connection, i.e. adhesion, to the opposite plate to be improved. It has been found that the thermally expandable preparations according to the invention have improved adhesion in particular in narrow regions of the system to be sealed, since the foam itself penetrates the smallest of corners and at acute angles, and therefore it is possible for the system to be sealed in a more complete manner.

The present invention preferably also relates to compositions which contain, as binders and curing agents,
at least one triglyceride fraction of which the fatty acid distribution has a proportion of at least 5 wt. %, in particular of at least 60 wt. %, of one or more Ω-3 fatty acids and/or one or more Ω-6 fatty acids,
at least one vulcanizing agent selected from the group consisting of
   sulfur,
   peroxidic vulcanizing agents,
   quinones and/or quinone dioximes, and/or
   dinitrosobenzolene; and
optionally at least one synthetic polymer that contains at least one C═C double bond and/or at least one C≡C triple bond.

The at least one triglyceride fraction has a fatty acid distribution having a proportion of at least 5 wt. %, in particular at least 10 wt. %, more particularly preferably at least 60 wt. %, of one or more Ω-3 fatty acids and/or one or more Ω-6 fatty acids.

According to the invention, a “triglyceride fraction” is understood to mean the sum of all triglycerides contained in the preparation, i.e. the triple ester of glycerol comprising three fatty acid molecules. It makes no difference to the determination of the triglyceride fraction from which raw material used the triglycerides originate.

According to the invention, the fatty acid distribution of a triglyceride fraction indicates the weight proportions of the various fatty acids relative to the total weight of the fatty acids in the triglyceride fraction; the different proportions are usually determined by gas chromatography after the fatty acids have been released as methyl esters. Accordingly, the weight of glycerol is not included in this calculation.

Ω-3 fatty acids which are preferred according to the invention are: hexadecatrienoic acid (16:3; (ω-3)), alpha-linolenic acid (18:3 (ω-3)), stearidonic acid (18:4; (ω-3)), eicosatrienoic acid (20:3; (ω-3)), eicosatetraenoic acid (20:4; (ω-3)), eicosapentaenoic acid (20:5; (ω-3)), heneicosapentaenoic acid (21:5; (ω-3)), docosapentaenoic acid (22:5; (ω-3)), docosahexaenoic acid (22:6; (ω-3)), tetracosapentaenoic acid (24:5; (ω-3)) and tetracosahexaenoic acid (24:6; (ω-3)). Very particularly preferred Ω-3 fatty acids are alpha-linolenic acid (18:3 (ω-3)) and eicosapentaenoic acid (20:5; (ω-3)). Alpha-linolenic acid (18:3 (ω-3)) is a very particularly preferred Ω-3 fatty acid.

Ω-6 fatty acids which are preferred according to the invention are: linoleic acid (18:2; (ω-6)), gamma-linolenic acid (18:3; (ω-6)), calendic acid (18:3; (ω-6)), eicosadienoic acid (20:2; (ω-6)), dihomo-gamma-linolenic acid (20:3; (ω-6)), arachidonic acid (20:4; (ω-6)), docosadienoic acid (22:2; (ω-6)), docosatetraenoic acid (22:4; (ω-6)), docosapentaenoic acid (22:5; (ω-6)), tetracosatetraenoic acid (24:4; (ω-6)) and tetracosapentaenoic acid (24:5; (ω-6)).

Particularly preferred Ω-6 fatty acids are linoleic acid (18:2; (ω-6)), gamma-linolenic acid (18:3; (ω-6)) and arachidonic acid (20:4; (ω-6)), linoleic acid (18:2 (ω-6)) being a very particularly preferred Ω-6 fatty acid.

Particularly good mechanical properties could be obtained if the triglyceride fraction has a fatty acid distribution having a proportion of at least 4 wt. %, in particular at least 15 wt. %, of one or more Ω-3 fatty acids.

It has been found to be advantageous according to the invention for at least 40 wt. %, in particular 60 wt. %, very particularly 100 wt. %, of the triglyceride fraction to be liquid at 25° C., i.e. present in the form of an oil.

Furthermore, it has been found to be advantageous for the triglyceride fraction having the proportions of Ω-3 fatty acids and/or Ω-6 fatty acids to originate from a natural source, for example corresponding vegetable and/or animal oils. Although vegetable oils are particularly preferred, the use of animal oils, such as fish oil or cod liver oil, is also covered.

Triglyceride fractions according to the invention are contained, for example, in sunflower oil, rapeseed oil, soybean oil, tall oil, camelina oil, tung oil, linseed oil and/or hemp oil. Rapeseed oil, soybean oil, tall oil, camelina oil, tung oil, linseed oil and/or hemp oil are preferred according to the invention; tall oil, camelina oil, tung oil, linseed oil and/or hemp oil are particularly preferred according to the invention; tung oil, linseed oil and hemp oil are more particularly preferred according to the invention. The use of linseed oil is very particularly preferred. The use of a combination of two, three or more suitable oils is also preferred.

The triglyceride fraction, or the oil containing the triglyceride fraction, is contained in the compositions according to the invention preferably in an amount of from 5 to 50 wt. %, in particular from 10 to 40 wt. %.

As a curing agent for the triglyceride fraction, the compositions preferably contain at least one specially selected vulcanizing system selected from the group consisting of:

(b1) sulfur,
(b2) peroxide vulcanizing systems,
(b3) quinones and/or quinone dioximes, and/or
(b4) dinitrosobenzenes.

In a first preferred embodiment, synthetic or natural sulfur is used as the vulcanizing agent. Preferably, powdered sulfur is used according to the invention; however, in order to prevent dust pollution during production, it may also be preferable to use sulfur mixed with a dust-binding agent, for example mixed with mineral oil, paraffin oil or silicon dioxide. The content of the dust-binding oils may well be selected such that a sulfur-containing paste is used as a raw material. Sulfur is preferably used in the S8 configuration.

The active substance content of sulfur in the preparations according to the invention can vary within wide limits; it can be up to 20 wt. %, preferably up to approximately 15 wt. %, in particular up to 10 wt. %, based in each case on the total preparation; the lower limit should preferably be no less than 0.5 wt. %. The sulfur content is dependent on the reactivity of the system used and possibly on the use of polymerization additives.

In a second preferred embodiment, radical vulcanizing agents based on organic or inorganic peroxides are used. Examples of peroxides which are preferred according to the invention are diacetyl peroxide, di-tert-butyl peroxide, dicumyl peroxide and dibenzoyl peroxide. The peroxides are contained, as vulcanizing agents, in the preparations according to the invention in amounts of from 0.2 wt. % to 3 wt. %.

In a third preferred embodiment, quinones and/or quinone dioximes are used as vulcanizing agents. A particularly preferred representative of this group is p-benzoquinone dioxime. The quinones and/or quinone dioximes are used in the compositions preferably in concentrations of from 0.2 wt. % to 5 wt. %.

These quinone-based vulcanizing agents are preferably used in a phlegmatized and paste form, for example when mixed with substances such as mineral oils, the active substance content usually being 40 wt. % and 70 wt. %, respectively.

Sulfur is a very particularly preferred vulcanizing agent as a curing agent for the triglyceride fraction.

In a fourth preferred embodiment, dinitrosobenzenes, in particular 1,4-dinitrosobenzene, are used as vulcanizing agents. This substance group is preferably used in the preparations according to the invention in a concentration of from 0.2 wt. % to 5 wt. %, based in each case on the entire heat-curable preparation.

It has been found to be particularly advantageous, regardless of the specific embodiment, for the vulcanizing agent to be used in combination with organic curing accelerators, such as mercaptobenzothiazole, dithiocarbamates, sulfenamides, disulfides such as dibenzothiazole disulfide and/or thiuram disulfides, aldehyde-amine accelerators, guanidines, and/or metal oxides such as zinc oxide. In addition, typical rubber vulcanizing auxiliary agents, such as fatty acids (for example stearic acid), may also be present in the formulation.

The content of the organic curing accelerator may preferably vary between 0 and approximately 10 wt. %. The content of metal oxides is preferably also in the range between 0 and 10 wt. %.

Furthermore, it has been found to be advantageous for the heat-curable preparations to also comprise, in addition to the unsaturated triglyceride fraction, at least one synthetic polymer that contains at least one C═C double bond and/or at least one C≡C triple bond. These polymers are preferably selected from the following group of homopolymers and/or copolymers:
polybutadienes, in particular 1,4-polybutadiene and 1,2-polybutadiene,
polybutenes,
polyisobutylenes,
1,4-polyisoprenes,
styrene-butadiene copolymers and
butadiene acrylonitrile copolymers,
   it being possible for these polymers to have terminal and/or (randomly distributed) pendant functional groups. Examples of functional groups of this kind are hydroxy, carboxyl, carboxylic anhydride or epoxy groups, in particular maleic anhydride groups. These polymers can be selected in particular from the above-mentioned polyenes and be present in the same amounts.

The expandable preparations very particularly preferably contain at least one (meth)acrylate-based polymer as a binder. Corresponding polymers or copolymers are based on (meth)acrylate acid or (meth)acrylate esters, such as C1 to C6-alkyl esters of acrylic acid and methacrylic acid, and contain these in particular at 50 wt. %, preferably 80 wt. %, in particular 95 wt. %. Particularly preferably, the expandable preparations contain, as a binder, at least one (meth)acrylate polymer, which consists only of (meth)acrylate acid units or (meth)acrylate ester units, in particular (meth)acrylate ester units. Corresponding polymers can also be functionalized via the ester group or by polymerized monomers.

Preferred monomers from which the (meth)acrylate-based polymer is built up include, for example, methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl (meth)acrylate and hydroxypropyl (meth)acrylate. In addition, the polymers can contain, preferably in small proportions (<5 wt. %), additional monomers with an unsaturated group, such as (meth)acrylamide, (meth)acrylonitrile, styrene, substituted styrenes, butadiene, vinyl acetate, vinyl butyrate and other vinyl esters and vinyl monomers such as ethylene, vinyl chloride, vinylidene chloride. However, the (meth)acrylate-based polymer is preferably substantially free of additional monomers with an unsaturated group. The use of the term “(meth),” followed by another term such as acrylate or acrylamide, as used throughout the disclosure, relates to both acrylates or acrylamides and methacrylates or methacrylamides.

The thermally expandable preparations particularly preferably contain a methyl (meth)acrylate or a butyl (meth)acrylate as a binder.

The glass transition temperature (“Tg”) of the (meth)acrylate-based polymer is preferably from −30° C. to 50° C., more preferably from −10° C. to 20° C. The Tg value can be determined by means of differential scanning calorimetry (DSC) by measuring the midpoint of the heat flow against the temperature transition. The desired polymer Tg range can be set by the selection of the monomers and the amounts of the monomers.

It is particularly advantageous if the thermally expandable preparations according to the invention contain, as a binder, the at least one (meth)acrylate-based polymer in an amount of from 3 to 30 wt. %, in particular from 5 to 20 wt. %, based on the total mass of the thermally expandable preparation.

The (meth)acrylate-based polymer is particularly preferably introduced into the preparation in the form of an aqueous emulsion.

As a further component that is essential to the invention, the thermally expandable preparations according to the invention contain a physical blowing agent. Expandable plastics hollow microspheres in particular based on polyvinylidene chloride copolymers or acrylonitrile/(meth)acrylate copolymers are preferably used as physical blowing agents. These are commercially available, for example, under the names “Dualite®” and “Expancel®” from Pierce & Stevens and Akzo Nobel, respectively.

The thermally expandable preparations particularly preferably contain a physical blowing agent which begins to expand below 100° C., in particular below 85° C., particularly preferably in a temperature range of from 50 to 100° C., in particular from 50 to 85° C.

It has been found to be particularly advantageous if the thermally expandable preparations according to the invention contain the at least one physical blowing agent in an amount of from 0.05 to 5 wt. %, in particular from 0.1 to 1 wt. %, based on the total mass of the thermally expandable preparation.

In a preferred embodiment, the thermally expandable preparation is substantially free of ADCA (azodicarbonamide) and/or OBSH (4,4′-oxybis(benzenesulfonylhydrazide)), in particular substantially free of exothermic chemical blowing agents, preferably substantially free of chemical blowing agents. According to the invention, thermally expandable preparations are “substantially free of” if they contain less than 1 wt. %, preferably less than 0.5 wt. %, very particularly preferably less than 0.1 wt. %, of one of the components, in particular do not contain the component at all.

As a further component essential to the invention, the thermally expandable compositions contain at least two polysaccharides. A polysaccharide is preferably to be understood to mean molecules in which at least 10 monosaccharide molecules are linked via a glycosidic bond. Preferred examples include cellulose, starch (amylose and amylopectin), pectin, chitin, chitosan, glycogen, callose, and the derivatives thereof. Particularly preferably, at least two celluloses or at least two starches or mixtures thereof, in particular at least two starches, are contained in the thermally expandable composition. The at least two polysaccharides are at least two different polysaccharides.

The use of the polysaccharides, in particular of celluloses and/or starches, especially two starches, has a particularly advantageous effect on the storage stability and in particular on the bubble formation behavior, although at the same time the polysaccharides do not negatively influence the expansion behavior, but rather improve it. The use of polysaccharides, in particular starches in combination with physical blowing agents, improved both the properties of the preparation itself, for example with regard to storage stability and bubble formation during expansion, and the properties of the foam, for example with regard to adhesion and moisture absorption.

In the case of the celluloses preferred according to the invention, cellulose derivatives can in principle be used in all available modifications, molecular weights, degrees of branching and substitution patterns. Preferred examples are methyl cellulose, hydroxyethyl cellulose, hydroxyethylmethyl cellulose, hydroxypropyl cellulose, hydroxypropylmethyl cellulose, hydroxypropylethyl cellulose, carboxymethyl cellulose and cetylhydroxyethyl cellulose.

The cellulose is particularly preferably used in the form of a cellulose powder, such as wood dust. The cellulose powders particularly preferably have a grain/fiber size distribution (quantities in wt. %) of >30%, in particular >60%, preferably >90%, smaller than 32 μm, and preferably additionally >70%, in particular >90%, preferably >100%, smaller than 100 μm (sieve residue on Alpine air jet sieve according to DIN EN ISO 8130-1).

The starches preferred in the context of the invention generally consist substantially of amylose and amylopectin in varying proportions. The starches preferably have an amylopectin content of >50 wt. %, in particular >80 wt. %, preferably >95 wt. %, particularly preferably >99 wt. %, based on the total weight of the particular starch.

The starches can be native, anionically and/or cationically modified, esterified, etherified and/or crosslinked. Native and/or anionic starches are preferred. Starches based on potato starch, corn starch, waxy corn starch, rice starch, wheat starch (generally cereal starches) or tapioca starch (manioc) are particularly preferred. In the course of the tests, particularly good results were achieved with starches based on potato starch, and therefore starches based on potato starch, in particular native potato starch and/or chemically modified potato starch, such as phosphated hydoxypropyl-modified potato starch, are particularly preferred.

Suitable starches are in principle all starches that can be generated from natural occurrences. Suitable starch examples are starch from potatoes, tapioca, cassava, rice, wheat or corn. Further examples are starches from maranta, sweet potato, rye, barley, millet, oats, sorghum, starches from fruits such as chestnuts, acorns, beans, peas and other legumes, bananas, and plant pulp, for example the sago palm.

In addition to starches of vegetable origin, it is also possible to use starches that have been chemically modified, obtained by fermentation, are of recombinant origin or have been produced by biotransformation or biocatalysis. By “chemically modified starches” the invention refers to starches in which the properties have been chemically changed in comparison with the natural properties. This is substantially achieved through polymer-analogous reactions in which starch is treated with mono-, bi- or polyfunctional reagents or oxidizing agents. The hydroxyl groups of the polyglucans of the starch are preferably converted by etherification, esterification or selective oxidation or the modification is based on a radically initiated graft copolymerization of copolymerizable unsaturated monomers onto the starch backbone.

Special chemically modified starches include starch esters such as xanthates, acetates, phosphates, sulfates, nitrates, starch ethers such as non-ionic, anionic or cationic starch ethers, oxidized starches such as dialdehyde starch, carboxy starch, persulfate-degraded starches and similar substances.

Preferred chemical modifications include phosphating, hydroxypropylation, acetylation and ethylation.

In the context of the invention, “starches produced by biotransformation” means that starches, amylose, amylopectin or polyglucans are produced by the catalytic reaction of monomeric basic building blocks, generally oligomeric saccharides, in particular mono- and disaccharides, by a biocatalyst (also: enzyme) being used under special conditions. Examples of starches from biocatalytic processes include polyglucan and modified polyglucans, polyfructan and modified polyfructans.

In principle, any anionic or cationic group that is suitable for modifying starch can be used for the purpose of chemical modification.

Examples of anionic groups are carboxyl groups, phosphate groups, sulfate groups, borate groups, phosphonate groups and sulfonate groups.

Of these, phosphate, borate and sulfate groups are particularly preferred, and among the sulfate groups, in particular those from the reaction with sulfuric acid; phosphate groups are particularly preferred.

Examples of cationic groups are tertiary amino groups, quaternary ammonium groups, tertiary phosphine groups, quaternary phosphonium groups, imino groups, sulfide groups and sulfonium groups.

Of these, amino and ammonium groups are particularly preferred.

These groups can be present in the starch molecule in a free form or in the form of the salts thereof. A starch molecule can also be substituted with different anionic or cationic groups, which can also be introduced via different substituent-introducing compounds and via different reactions.

Methods and compounds for introducing these groups are familiar and generally known to a person skilled in the art.

In the case of phosphate, sulfate or borate, the corresponding starch derivatives can be obtained by reacting the free inorganic acids; for example, in the case of phosphate, phosphoric acid or its esters can be obtained.

Carboxyl groups can, for example, be introduced via nucleophilic substitution or a variant related to the Michael addition. An example of the first type of reaction is the reaction of starch with chloroacetic acid; an example of the second type of reaction is the addition of maleic anhydride to the starch backbone. Mention should also be made of the reaction with hydroxycarboxylic acid in a synthesis analogous to Williamson's ether synthesis. In this way, e.g. through the use of malic acid, citric acid or tartaric acid with an etherification reaction, more than one carboxyl group can be coupled to a hydroxyl group of the starch at the same time.

In addition, compounds which, for example, contain at least two carboxyl groups, such as dicarboxylic acids etc., are coupled to the starch backbone via esterification of a carboxyl group with a hydroxyl group.

Cationic starch derivatives can be obtained as follows: For the coupling of amino functions, among other things, all derivatives can be used that are chemically activated in such a way that they are, for example, brought to reaction by a nucleophilic substitution, by an addition or by a condensation. An example of the first type of reaction is trimethylammonium chloride or 2-diethylaminoethyl chloride. The ionic structure is obtained either through direct reaction with the corresponding salt or through the subsequent addition of hydrochloric acid. Reactions with epoxy groups in the side group of the nitrogen-containing reagent can be seen as addition products. Examples are 2,3-(epoxypropyl)diethylammonium chloride or the hydrochloride thereof or 2,3-(epoxypropyl)trimethylammonium chloride. Coupling by condensation occurs when, during the reaction between starch and the reagent that introduces the ionic groups, condensation products such as water or methanol and the like are split off.

Moreover, in addition to the anionic or cationic groups, other functional groups can also be present as substituents in the starch.

Examples are non-ionic substituents which, for example, can form ether or ester functions.

In the case of the attachment of further substituents to the starch backbone via ether links, the following options are possible, for example: alkyl such as methyl, ethyl, propyl, butyl, alkenyl, hydroxyalkyl, e.g. hydroxyethyl, hydroxypropyl. For the coupling via ester groups, the reaction with acetic anhydride is most important, through which the starch acetate derivatives are formed. Further substituents can be introduced by reaction with propionic acid, butyric acid and the higher fatty acids, in particular from natural metabolism, such as lauric acid, oleic acid, etc. An ether linkage is particularly preferred, in particular with hydroxyalkyl, preferably hydroxypropyl.

Polysaccharides, in particular starches and/or celluloses, preferably starches having a gelation temperature of at least 40° C., preferably of at least 50° C., are particularly preferred. In particular, the starches have a gelation temperature of 40 to 200° C., preferably 50 to 150° C. Corresponding starches have a positive effect on storage stability with improved expansion.

In particular, the use of more than one polysaccharide, preferably more than one starch and/or more than one cellulose, in particular more than one starch, is advantageous. The starches preferably have different gelation temperatures, the polysaccharide 1 or starch 1 having a gelation temperature in the range of 50-100° C. and the second polysaccharide 2 or at least the second, preferably modified starch 2 having a gelation temperature in the range 80-150° C.

Gelation describes the swelling of the polysaccharide. In order to determine the gelation/gelatinization temperature, the transition of the polysaccharide or the starch at the temperature of the swelling is taken as a basis. The gelation temperature can be determined by means of dynamic differential calorimetry DSC or by means of microscopy with polarized light and observation of the beginning swelling, preferably by means of DSC.

In a preferred embodiment, the thermally expandable compositions contain a combination of a cold-soluble starch and a warm-soluble starch. In a preferred embodiment, at least one cold-swelling starch and at least one hydroxylated, in particular hydroxypropylated, starch are contained in the thermally expandable compositions.

In various embodiments, the thermally expandable compositions contain the at least two polysaccharides, preferably the at least two starches or at least two celluloses or mixtures thereof, in particular the at least two starches, in an amount of 0.1 to 20 wt. %, in particular 0.5 to 15 wt. %, preferably 1 to 10 wt. %, particularly preferably 2 to 5 wt. %, based on the total composition. Unless indicated otherwise, the amounts in wt. % given here are based on the total composition prior to expansion.

In particular, commercially available starches and starch derivatives can also be used, for example from Avebe, Cerestar, National Starch, Purac and Südstärke.

The thermally expandable preparations according to the invention also contain water. It has proven to be particularly advantageous if the thermally expandable preparations according to the invention contain water in an amount of from 0.5 to 30 wt. %, in particular from 1 to 20 wt. %, preferably 5 to 15 wt. %, based on the total mass of the thermally expandable preparation.

Particularly preferably, the preparation additionally contains at least one graphite, in particular a graphite having a particle size of 20-200 μm. Graphite, in particular graphite having the large particle size described, has a particularly advantageous effect on the soundproofing properties. It was surprising that graphite having the large particle size described could even be incorporated into the aqueous systems without adversely affecting the storage stability and the expansion behavior. This is mainly due to the use of at least two starches. The thermally expandable preparations according to the invention advantageously contain graphite in an amount of from 5 to 30 wt. %, in particular from 10 to 25 wt. %, based on the total mass of the thermally expandable preparation.

In addition to the constituents mentioned, the thermally expandable compounds can also contain other customary components, such as dyes, fillers and antioxidants.

Fillers include, for example, the various ground or precipitated chalks, calcium magnesium carbonates, talc, barite, silicic acid or silica and in particular silicate fillers such as mica, for example in the form of chlorite, or silicate fillers of the aluminum-magnesium-calcium silicate type, for example wollastonite. Talc is a particularly preferred filler.

The fillers are preferably used in an amount of 0 to 70 wt. %, in particular 30 to 60 wt. %, in each case based on the mass of the entire thermally expandable preparation.

Chromophoric components, in particular black dyes based on carbon blacks, are preferably contained in the thermally expandable preparations according to the invention in an amount of 0 to 8 wt. %, in particular of 0.1 to 4 wt. %, in each case based on the mass of the entire thermally expandable preparation.

It is possible to use, for example, sterically hindered phenols and/or sterically hindered thioethers and/or sterically hindered aromatic amines, for example bis-(3,3-bis-(4′-hydroxy-3-tert-butylphenyl)butanoic acid)glycol ester as antioxidants or stabilizers.

Antioxidants or stabilizers are preferably contained in the thermally expandable preparations according to the invention in an amount of 0 to 2 wt. %, in particular of 0.1 to 0.5 wt. %, in each case based on the mass of the entire thermally expandable preparation.

The thermally expandable preparations according to the invention can be prepared by mixing the selected components in any suitable mixer, for example a dispersion mixer, a planetary mixer, a twin-screw mixer, a continuous mixer or an extruder, in particular a twin-screw extruder.

Although it can be advantageous to heat the components slightly to make it easier to achieve a homogeneous and uniform compound, care must be taken to ensure that temperatures which cause the optionally present thermally activatable curing agent and/or the blowing agent to be activated are not reached.

Until they are used, the preparations according to the invention are preferably stored in containers/tankers/nozzle cartridges or barrels, such as sealed drums.

The compositions according to the invention are preferably characterized in that they can be heated reversibly (without a significant change in the temperature-dependent viscosity behavior) to temperatures of up to 70° C. and can therefore be transported by means of heated pumps and/or shaped several times within this temperature range.

In addition, the preparations according to the invention are preferably pumpable at application temperatures. Preparations which are “pumpable at application temperatures” are particularly preferred in the sense that said preparations have, at 60° C. and a pump pressure of 6 bar, a flow rate of at least 100 g/min, preferably of 150 g/min to 4,500 g/min, more preferably of 250 g/min to 3,000 g/min, when discharged from a completely filled, commercially available aluminum nozzle cartridge which has a capacity of 310 ml and an internal diameter of 46 mm, and the outlet opening of which has been opened by means of a cartridge piercing tool having an external diameter of 9 mm, without attaching a nozzle, at a temperature of 60° C. (after pre-heating for 45 minutes) and a pressure of 6 bar. The flow rate indicates the mass of preparation that can be discharged within 1 minute, and is accordingly given in g/min.

At the time of use, the preparation according to the invention is transported from the storage container to the application site and is applied at said site using conventional heated pumps. Said preparation can be applied to a layer thickness of 5 cm without difficulty, such that even relatively large cavities, such as tubes having a corresponding internal diameter, can easily be filled.

The thermally expandable preparation applied expands by being heated, the preparation being heated for a particular time period and to a particular temperature which is sufficient for bringing about the activation of the blowing agent and the optionally present curing agent system.

Depending on the composition of the preparation and the requirements of the production line, these temperatures are usually in the range of 100° C. to 240° C., preferably of 140° C. to 200° C., with a residence time of 10 to 90 minutes, preferably of 15 to 60 minutes.

In principle, the type of the heat source is not important, and so the heat can be supplied for example by a hot air blower, by irradiation with microwaves, by magnetic induction, or by heating tongs. In the field of vehicle construction and in fields of technology involving associated production processes, it is particularly advantageous for the preparations according to the invention to expand when the vehicle passes through the furnace for curing the cathodic dip paint or for baking the powder coatings, and therefore a separate heating step can be dispensed with.

The preparation according to the invention has, after expansion and optionally thermal curing, a loss factor CLF (composite loss factor) measured with an Oberst method for an application of 3 kg/m² which, at a temperature in the range of −5° C. to +40° C., is at least 0.1, preferably at least 0.2, in particular 0.25, which expresses the good acoustic damping behavior. “At a temperature in the range of −5° C. to +40° C.” means that the specified minimum value for CLF is reached at any temperature in the specified range. The loss factor CLF can be determined with an “Oberst analysis” based on DIN EN ISO 6721:

The present invention secondly relates to a method for soundproofing structural components having in particular thin-walled structures, in particular tubular structures. In such methods, a thermally expandable preparation according to the invention can be applied to the surface of the structure or of the structural component at a temperature below 120° C., preferably pumpable at a pump pressure of less than 200 bar, and this preparation can be cured at a later point in time, preferably at temperatures above 130° C. The curing leads to the thermally expandable preparation expanding, thus stiffening the structural component/sealing the cavity.

According to the invention, the preparations are particularly preferably applied in a temperature range of 30° C. to 80° C.

Application at an application pressure of from 6 bar to 180 bar is also particularly preferred.

The actual curing takes place according to the invention at a “later point in time.” For example, according to the invention, it is conceivable that the structural components be coated/filled with the pumpable, thermally expandable preparations and then put into intermediate storage. Intermediate storage may also include, for example, transportation to another plant. Such intermediate storage can last up to several weeks.

In another embodiment, however, it is also conceivable that the structural components be subject to a curing step shortly after being coated/filled with the pumpable, thermally expandable preparation. This may take place immediately or, in the case of assembly-line production, after arriving at one of the subsequent stations. In the context of this embodiment, it is particularly preferable according to the invention for the curing step to take place within 24 h, in particular within 3 h, after the preparations according to the invention have been applied.

The pumpable, thermally activated preparations according to the invention, or the foams resulting therefrom, can be used in all products in order to achieve soundproofing. In addition to vehicles, these include aircraft, domestic appliances, furniture, buildings, walls, partitions or boats, for example.

In the field of vehicle construction, the use of the preparations according to the invention has been found to be advantageous particularly for the construction of the driver's safety cage or the passenger compartment, since it can provide the structure with a large amount of stability and, at the same time, a low weight. The preparation according to the invention can be used advantageously in particular in the construction of all classes of racing cars (Formula I, touring cars, rally vehicles, etc.).

The present invention also relates to a structural component which optionally has a thin-walled structure and has been soundproofed by means of a preparation according to the invention.

All embodiments disclosed in connection with the preparations of the inventions can also be transferred to the methods and uses and vice versa.

### EXAMPLES

The following thermally expandable preparations were produced. Unless otherwise noted, the quantitative data are given in weight percent.

| Component | Example 1 | Example 2 | Example 3 | Example 4 |
|---|---|---|---|---|
| Acrylic-based binder | 24.3 | 13.74 | 11.633 | 13.74 |
| system 1 | | | | |
| (~51% solids in water) | | | | |
| Acrylic-based binder | 0 | 11.06 | 0 | 0 |
| system 2 | | | | |
| (~50% solids in | | | | |
| water; Tg 0° C.) | | | | |
| Acrylic-based binder | 0 | 0 | 0 | 11.06 |
| system 3 | | | | |
| (~51% solids in | | | | |
| water; Tg 0° C.) | | | | |
| Acrylic-based binder | 0 | 0 | 12.167 | 0 |
| system 4 | | | | |
| (~52% solids in | | | | |
| water; Tg 15° C.) | | | | |
| Water | 2.0 | 6.07 | 5.218 | 6.07 |
| Dispersing agents | 0.4 | 0.8 | 1.4 | 0.8 |
| Surfactant | 0.316 | 0.316 | 0.316 | 0.316 |
| Amino alcohol | 0.3 | 0.3 | 0.3 | 0.3 |
| Hydroxypropylated | 2.3 | 2.3 | 2.3 | 2.3 |
| potato starch | | | | |
| Cold swelling potato | 0.364 | 0.364 | 0.364 | 0.364 |
| starch | | | | |
| Carbon black | 20.0 | 16.5 | 18.5 | 16.5 |
| Hollow microspheres | 0.208 | 0.208 | 0.265 | 0.208 |
| (starting temperature | | | | |
| for expansion 80° C.) | | | | |
| Calcium carbonate | 42.962 | 43.752 | 43.807 | 44.262 |
| Bactericidal agent | 0.15 | 0.15 | 0.15 | 0.15 |
| Diethylene glycol | 1.5 | 1.5 | 0.99 | 0.99 |
| Glycerol | 0 | 0.99 | 0.99 | 0.99 |
| Rheological agents | 0.45 | 0.45 | 0.45 | 0.45 |
| Wax | 0 | 1.5 | 1.15 | 1.5 |

In order to produce the thermally expandable preparations according to the invention, the contained components were processed in the planetary mixer, with cooling to below 20° C., to form a homogeneous composition.

### Determination of Expansion

In order to determine the expansion, the composition was applied and introduced into a convection oven which was heated to the temperatures specified below (heating time approximately 7 to 10 minutes). The sample was then left at this temperature for 30 min.

The degree of expansion [%] was determined by the water displacement method according to the expansion formula

$$Expansion = \frac{( m 2 - m 1 )}{m 1} \times 100$$

m1=mass of the sample in the original state in deionized water

m2=mass of the sample after expansion in deionized water.

| Temperature [° C.] | Expansion of Example 1 |
|---|---|
| 125° C. | 81% |
| 145° C. | 80% |
| 165° C. | 82% |
| 205° C. | 84% |

The example formulation showed a uniform expansion over a wide temperature range. In addition, the expanded samples were bubble-free at all temperatures. Furthermore, the samples showed excellent soundproofing properties.

What is claimed is:

1. A thermally expandable preparation, containing:
(a) at least one binder;
(b) at least one physical blowing agent;
(c) at least two different polysaccharides; and
(d) water;
wherein the at least one binder comprises at least one (meth)acrylate-based polymer.

2. The thermally expandable preparation according to claim 1, wherein (a) the at least one binder further comprises one or more selected from the group of epoxides, thermoplastic elastomers and peroxidically crosslinkable polymers.

3. The thermally expandable preparation according to claim 1, wherein the at least one (meth)acrylate-based polymer is present in an amount of from about 3 wt. % to about 30 wt. %, based on total mass of the thermally expandable preparation.

4. The thermally expandable preparation according to claim 1, wherein (b) the at least one physical blowing agent comprises expandable hollow plastic microspheres.

5. The thermally expandable preparation according to claim 4, wherein the expandable hollow plastic microspheres are based on polyvinylidene chloride copolymers or acrylonitrile/(meth)acrylate copolymers.

6. The thermally expandable preparation according to claim 4, wherein the at least one physical blowing agent is present in an amount of from 0.05 to 5 wt. %, based on total mass of the thermally expandable preparation.

7. The thermally expandable preparation according to claim 4, wherein (c) the at least two different polysaccharides comprises:
a. at least two celluloses,
b. at least two starches, or
c. a combination of celluloses and starches.

8. The thermally expandable preparation according to claim 1, wherein (c) is present in an amount of 0.1 to 20 wt. %, based on the total composition; and the preparation is pumpable.

9. The thermally expandable preparation according to claim 8, wherein (c) the at least two different polysaccharides comprises at least two starches.

10. The thermally expandable preparation according to claim 9, wherein (c) comprises at least one cold-swelling starch and at least one hydroxylated starch.

11. The thermally expandable preparation according to claim 1, wherein the water is present in an amount of 1 to 20 wt. %, based on total mass of the thermally expandable preparation.

12. The thermally expandable preparation according to claim 1, further comprising at least one graphite having a particle size of about 20-200 μm.

13. The thermally expandable preparation according to claim 1, further comprising fillers, antioxidants, activators and/or dyes.

14. The thermally expandable preparation according to claim 1, wherein:
the at least one binder (a) is present in an amount of 2 to 65 wt. %, and the at least one (meth)acrylate-based polymer of (a) is selected from polymers or copolymers based on, optionally functionalized, C1 to C6-alkyl esters of acrylic acid and methacrylic acid;
the at least one physical blowing agent (b) is present in an amount of from 0.05 to 5 wt. %; and
component (c) the at least two different polysaccharides is present in an amount of 0.1 to 20 wt. % and comprises two different starches selected to have a different gelation temperatures, both gelation temperatures exceeding 40° C.

15. The thermally expandable preparation according to claim 14, wherein the at least one (meth)acrylate-based polymer of (a) comprises a methyl (meth)acrylate or a butyl (meth)acrylate polymer.

16. A method of soundproofing structural components comprising steps of:
a. applying a thermally expandable preparation according to claim 1, to a surface of a structural component; and thereafter
b. heat curing the thermally expandable preparation for a time period and to a temperature which is sufficient for bringing about activation of the at least one physical blowing agent and an optionally present curing agent.

17. The method of soundproofing structural components of claim 16, wherein the applying step comprises pumping the thermally expandable preparation at a temperature up to about 70° C., at a pump pressure of less than 200 bar.

18. A structural component, optionally having a thin-walled structure, soundproofed according to the method of claim 16.
